(19) United States
(12) Patent Application Publication
(10) Pub. No.: US 2020/0085232 A1
(43) Pub. Date: Mar. 19, 2020

(54) Method And Apparatus For Making Coffee And Other Beverages With Freshly Ground Ingredients

(71) Applicant: Zhouyue PI, Allen, TX (US)

(72) Inventor: Zhouyue PI, Allen, TX (US)

(21) Appl. No.: 16/210,467

(22) Filed: Dec. 5, 2018

Related U.S. Application Data
(60) Provisional application No. 62/733,181, filed on Sep. 19, 2018.

(51) Int. Cl. A47J 31/42; A47J 31/36; A47J 31/46

(52) U.S. Cl. CPC A47J 31/42; A47J 31/3628; B65D 85/8043; A47J 31/468; A47J 31/3633

(57) ABSTRACT

A beverage brewing machine comprising: i) a receptacle configured to receive a pod, the pod containing an ingredient to be brewed; ii) a grinding apparatus configured to grind large pieces of the ingredient into grounds suitable for brewing, the grinding apparatus having an intake and an exit; iii) a transfer mechanism configured to transfer the large pieces of the ingredient from the pod to the grinding apparatus intake and further configured to transfer the grounds from the grinding apparatus exit back to the pod; and iv) a water pump configured to inject water into the pod to thereby brew the grounds and produce a brewed beverage. The pod for brewing a beverage comprises: i) an outer shell configured to form an enclosure; ii) a filter that lines the interior of the outer shell; iii) large pieces of ingredients within the enclosure, the large pieces of ingredients to be ground or blended before brewing; and iv) a pod cover that covers the enclosure. The large pieces of ingredients are disposed within the filter inside the outer shell.

### CROSS-REFERENCE TO RELATED APPLICATION(S) AND CLAIM OF PRIORITY

The present application is related to U.S. Provisional Patent No. 62/733,181, filed Sep. 19, 2018, entitled “Method And Apparatus For Making Coffee And Other Beverages With Freshly Ground Ingredients”. Provisional Patent No. 62/733,181 is assigned to the assignee of the present application and is hereby incorporated by reference into the present application as if fully set forth herein. The present application hereby claims priority under 35 U.S.C. § 119(e) to U.S. Provisional Patent No. 62/733,181.

### TECHNICAL FIELD

The present disclosure relates generally to beverage making pods and machines and, more specifically, to a coffee machine that grinds and then brews fresh coffee beans in single-serving pods.

### BACKGROUND

Coffee machines using single-serving coffee pods have become popular in recent years. Successful examples include Keurig and Nespresso coffee machines. These conventional single-serving coffee machines make coffee from single-serving coffee pods that holds coffee grounds. The coffee machine heats up water and passes the hot water through the coffee grounds in the coffee pod to make a coffee drink. Typically, the coffee pod is discarded after a cup of coffee is made. There are many different variants of coffee pods with different kinds of coffee grounds and different flavors. Some coffee machines also make non-coffee drinks, such as hot cocoa or hot tea. A drawback of these conventional single-serving coffee machines is that the coffee beans must be ground before being packaged into the pods. The delay between the time when the coffee beans are ground and the time when the coffee pods are consumed is often long and unpredictable. As a result, the coffee grounds lose freshness, which adversely affects the taste of the coffee.

FIG. 1 illustrates exemplary conventional single-serving coffee machine 100 using pre-packaged coffee grounds according to one embodiment of the prior art. In the exemplary embodiment, coffee machine 100 comprises water tank 105, water pump 110, heating element 115, hot water container 120, pod receptacle 125, motor 130, control unit 135, and user interface 140.

Water tank 105 may be either a tank (or similar reservoir) or a hose that is connected to an external water supply, such as a faucet or a residential plumbing pipe. Water pump 110 transfers water from tank 105 to heating element 115, which heats up the water. As water passes through the coffee grounds, the water temperature decreases. In some embodiments, a second heating element may be included after the hot coffee liquid exits pod receptacle 125, so that the final coffee is even hotter. In some embodiments, the hot water may optionally be stored in a reservoir, such as hot water container 120, inside coffee machine 100. This enables coffee machine 100 to produce hot water faster when the user wants to make a drink. In other embodiments, the heated water goes directly from heating element 115 to pod receptacle 125.

Single-serving coffee machine typically comprises a mechanical element, such as motor 130, that allows the pod receptacle 125 to open and close, so that the user can open pod receptacle 125 to insert a coffee pod, close receptacle 125 to make a drink, and then re-open pod receptacle 125 to remove the used coffee pod.

Control unit 135 comprises a processor and memory that controls the logic, the operations, and the states of the components in coffee machine 100 during a brewing cycle. For example, control unit 135 may control water pump 110 and heating element 115 so that the right amount of water with the desired temperature is poured into the coffee pod. Coffee machine 100 may comprise additional components (not shown), such as a water level sensor, that provide status information and other data to control unit 135. User interface 140 typically includes display units, buttons, LED indicators, and the like, that enable user to read the status of the coffee machine, to configure the coffee machine, and to control the brewing cycle.

Another type of coffee machine may receive whole coffee beans and grind the beans at the time of making coffee. FIG. 2 illustrates exemplary conventional coffee machine 200, which grinds whole coffee beans and brews the grounds according to one embodiment of the prior art. In the exemplary embodiment, coffee machine 200 comprises water tank 105, water pump 110, heating element 115, control unit 135, user interface 140, coffee bean container 205, grinder 210, and dripper 215. Water tank 105, water pump 110, heating element 115, control unit 135, and user interface 140 perform essentially the same functions as in FIG. 1 above and need not be discussed in additional detail.

Coffee bean container 205 is a container for holding whole coffee beans. The user typically pours the whole coffee beans from a package into container 205. When coffee machine 200 is activated, grinder 210 draws whole coffee beans from container 205 and grinds the whole coffee beans into grounds and then transfers the coffee grounds into dripper 215. Hot water flows from hearing element 115 into dripper 215 to make the final coffee. Coffee machines similar to coffee machine 200 generally have only a single container 205 for storing whole coffee beans. Dripper 215 typically contains a filter (not shown) that filters the coffee liquid to remove grounds. Dripper 215 and the filter must be cleaned and/or replaced after every grind-and-brew cycle.

Coffee machine 200 requires a fair amount of manual work from the user, such as adding coffee beans to coffee machine 200, cleaning dripper 215, replacing the filter, and the like. This overhead becomes more pronounced if the user wants to make only one or two cups of coffee. Also, it is difficult for the user to switch to different coffee flavors. It is generally necessary to consume all the coffee beans in container 205 before switching to another type of coffee bean.

Therefore, there is a need for improved apparatuses and methods for making single-servings of coffee using coffee pods.

### SUMMARY

The disclosure describes a new kind of beverage making methods and apparatus so that user can enjoy freshly ground coffee using single-serving coffee machines and coffee pods. This disclosure describes coffee pods packaged with whole or sliced coffee beans inside. Since coffee beans can maintain freshness much longer than coffee grounds, the methods and apparatuses described herein can greatly increase the freshness of single-serving pod based coffee drinks. The disclosed apparatus may be used to make coffee or other beverages with pre-packaged beverage-making ingredients such as beans, nuts, seeds, leaves, and the like. A pre-packaged pod containing the beverage-making ingredients is inserted into the beverage machine. The beverage-making ingredients (e.g., coffee beans) are processed by a blending or grinding apparatus and become finer granules. The processed granules are put back in the pod. Then water, which may be heated, is poured into the pod to make beverage.

Accordingly, it is an aspect of the present disclosure to provide a beverage brewing machine comprising: i) a receptacle configured to receive a pod, the pod containing an ingredient to be brewed; ii) a grinding apparatus configured to grind large pieces of the ingredient into grounds suitable for brewing, the grinding apparatus having an intake and an exit; iii) a transfer mechanism configured to move the pod to a first position that allows the large pieces of the ingredient to be transferred from the pod to the grinding apparatus intake and further configured to move the pod to a second position that allows the grounds to be transferred from the grinding apparatus exit back to the pod; and iv) a water pump configured to inject water into the pod to thereby brew the grounds and produce a brewed beverage.

In one embodiment, the transfer mechanism is manually operated by a user of the beverage brewing machine.

In another embodiment, the transfer mechanism further comprises a motor configured to move the pod between the first position and the second position.

In still another embodiment, the receptacle comprises a blade configured to form an opening in a cover of the pod, wherein the opening in the cover enables the large pieces of the ingredient to be transferred from the pod to the grinding apparatus intake when the pod is in the first position.

In yet another embodiment, the opening in the cover further enables the grounds to be transferred from the grinding apparatus exit to the pod when the pod is in the second position.

In a further embodiment, the opening in the cover enables the water to enter the pod.

In a still further embodiment, the blade is associated with a lid of the receptacle and forms the opening in the cover of the pod when the lid is closed on the pod.

In a yet further embodiment, the receptacle comprises a sharpened point configured to puncture a hole in the pod, wherein the hole in the pod enables the brewed beverage to exit the pod.

In one embodiment, the sharpened point is associated with a base of the receptacle and punctures the hole in the pod when the pod is inserted into the receptacle.

In another embodiment, the brewing machine further comprises a heating element configured to heat water from the pump, such that heated water is injected into the pod to thereby brew the grounds and produce a brewed beverage.

It is another aspect of the present disclosure to provide a method of brewing a beverage in a brewing machine comprising: i) inserting into the brewing machine a pod containing large pieces of an ingredient to be brewed; ii) transferring the large pieces of the ingredient from the pod into a grinding apparatus; iii) grinding the large pieces of the ingredient into grounds suitable for brewing; iv) transferring the grounds from the grinding apparatus back into the pod; and v) injecting water into the pod to thereby brew the grounds and produce a brewed beverage.

In one embodiment, the method further comprises moving the pod to a first position to allow the large pieces of the ingredient to be transferred from the pod into the grinding apparatus.

In another embodiment, the method further comprises moving the pod to a second position to allow the grounds to be transferred from the grinding apparatus back into the pod.

In still another embodiment, the method further comprises forming an opening in a cover of the pod to enable the large pieces of the ingredient to be transferred from the pod to the grinding apparatus.

It is still another aspect of the present disclosure to provide a pod for brewing a beverage. The pod comprises: i) an outer shell configured to form an enclosure; ii) a filter that lines the interior of the outer shell; iii) large pieces of ingredients within the enclosure, the large pieces of ingredients to be ground or blended before brewing; and iv) a pod cover that covers the enclosure.

In one embodiment, the large pieces of ingredients are disposed within the filter inside the outer shell.

In another embodiment, the filter, the outer shell, and the pod cover comprise a porous material.

In still another embodiment, the porous material is paper.

In yet another embodiment, the filter, the outer shell, and the pod cover are coated with food grade coating.

It is still another aspect of the present disclosure to provide a beverage brewing machine comprising: i) a receptacle configured to receive a pod, the pod containing an ingredient to be brewed; ii) a grinding apparatus configured to grind large pieces of the ingredient into grounds suitable for brewing, the grinding apparatus having an intake and an exit; iii) a transfer mechanism configured to transfer the large pieces of the ingredient from the pod to the grinding apparatus intake and further configured to transfer the grounds from the grinding apparatus exit back to the pod; and iv) a water pump configured to inject water into the pod to thereby brew the grounds and produce a brewed beverage.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary conventional coffee machine using pre-packaged coffee grounds.

FIG. 2 illustrates an exemplary conventional coffee machine that grinds whole coffee beans and brews the grounds according to one embodiment of the prior art.

FIG. 3 illustrates a pod that contains whole coffee beans according to an embodiment of the disclosure.

FIG. 4 illustrates a grind-and-brew beverage machine that use pods containing beverage-making ingredients similar to the pod in FIG. 3 according to an embodiment of the disclosure.

FIG. 5 illustrates a grind-and-brew coffee machine for pods containing whole or halved coffee beans according to an embodiment of the disclosure.

FIG. 6 illustrates in greater detail a grind-and-brew module of the grind-and-brew coffee machine in FIG. 5 for pods containing coffee beans according to an embodiment of the disclosure.

FIG. 7 is an exploded view illustrating a milling apparatus of a grind-and-brew coffee machine for pods containing coffee beans according to an embodiment of the disclosure.

FIG. 8 illustrates the pod holder of a grind-and-brew coffee machine for pods containing coffee beans according to an embodiment of the disclosure.

FIG. 9 is an illustration of the various states of the coffee machine in a grind-and-brew cycle according to an embodiment of the present disclosure.

FIG. 10 is an exemplary flow diagram illustrating a method of making coffee drinks using a grind-and-brew coffee machine with pods containing coffee beans according to an embodiment of the present disclosure.

### DETAILED DESCRIPTION

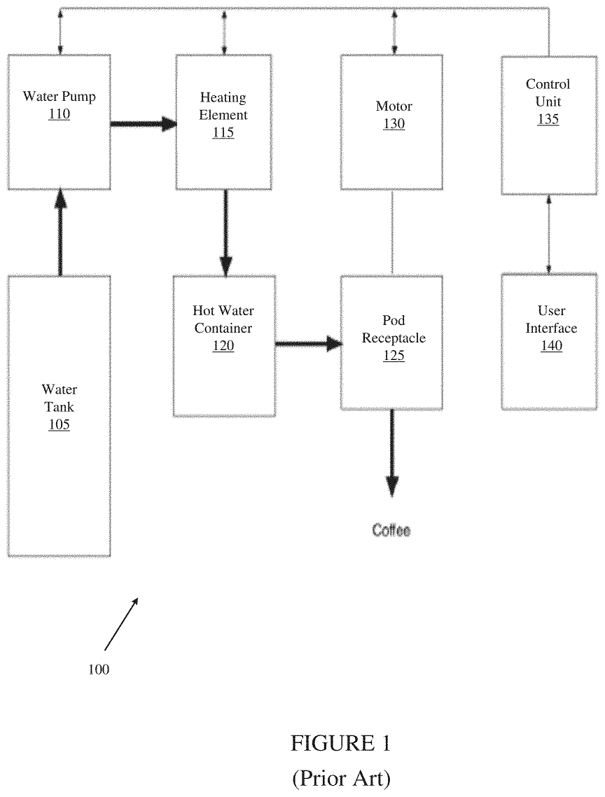

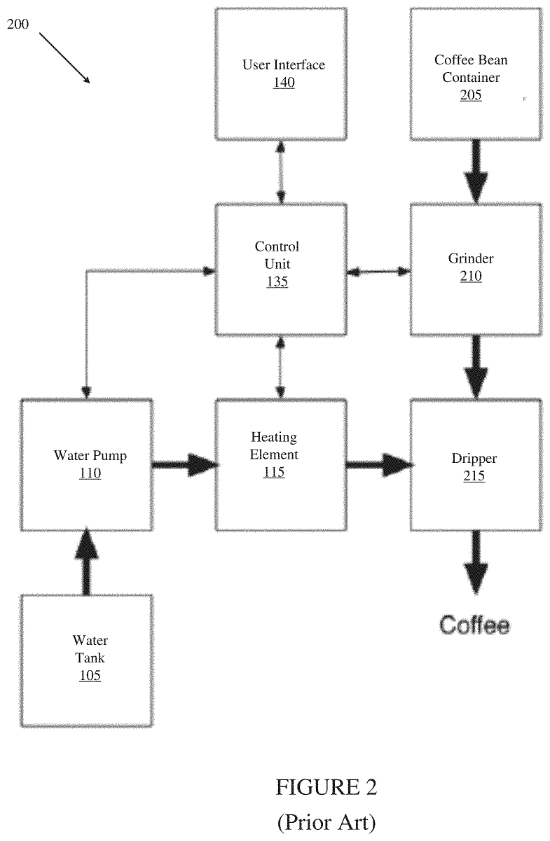

FIGS. 1 through 10, discussed herein, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged beverage brewing machine.

For purpose of illustration, the present disclosure describes coffee drinks, coffee beans, and pods containing coffee beans, as examples only. Those skilled in the art will understand that the present disclosure equally applies to pods containing other beverage-making ingredients including, but not limited to, tea leaves, soybeans, peanuts, almonds, sesame seeds, sunflower seeds, chocolate, and the like, that may be processed as or before water is added during the beverage-making process.

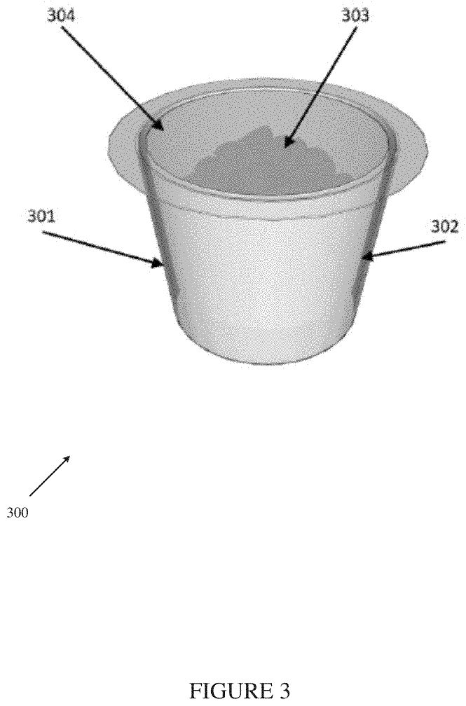

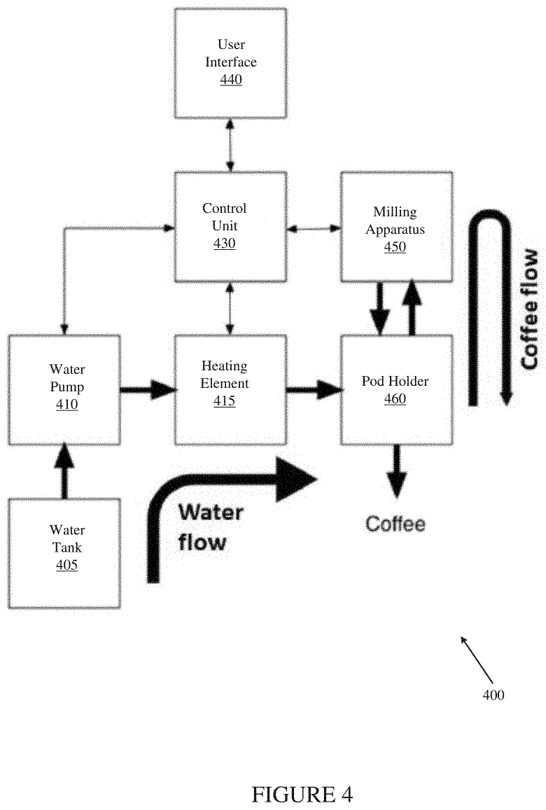

FIG. 3 illustrates pod 300, which contains whole coffee beans according to an embodiment of the present disclosure. Pod 300 stores coffee beans for making coffee using the grind-and-brew coffee machine shown in FIG. 4, which is discussed below in greater detail. Pod 300 comprises outer shell 301, filter 302 (inside shell 301), coffee beans 303 (inside shell 301), and cover 304. Outer shell 301 may generally be cup-shaped, bowl-shaped, or any other suitable shape such that shell 301 forms an enclosure (or inner chamber) that holds coffee beans 303 and filter 302. In an exemplary embodiment, filter 302 is made from a porous material and lines the inner surface of outer shell 301. Filter 302 strains the brewed beverage after coffee beans 303 have been converted to grounds and water has been injected into pod 300.

Pod 300 may be made using different materials, designs, and shapes without departing from the scope of this disclosure. For example, shell 301 may comprise plastic, metal, or paper materials. Additionally, shell 301 may be coated with a protective material. For example, for paper pods 300, shell 301 may be coated with wax or polyethylene (PE) to achieve a better seal for keeping the coffee beans fresh and away from moisture. For plastic and aluminum pods, shell 301 may be coated with a layer of material that avoids direct contact between the plastic or aluminum shell and hot water, thereby preventing release of harmful or distasteful chemicals into drinks.

Coffee beans 303 inside shell 301 may be whole beans or halved (or slivered) beans. The beans may be light, medium, or dark roasts. Filter 302 is typically made of paper or fiber, but certainly may also be made from plastic or metal. Cover 304 may also be made of metal foil, paper, or plastic. Preferably, pod 300 has an upper rim that projects outward to allow pod 300 to be better secured in position during the grind-and-brew cycle and allows for easy removal of pod 300 after the drink is made.

In a preferred embodiment of the present disclosure, pod 300 comprises a paper shell 301 with a wax or PE coating, a paper filter 302 inside pod 300, a paper cover 304, and coffee beans 303 inside paper filter 302. The wax or PE coating may be applied inside or outside of paper shell 301 or on both the inside and the outside. A wax or PE coating may also be applied to cover 304. If applied, the wax or PE coating on the inside of paper shell 301 and paper cover 304 should be food grade because the wax or PE coating may come in contact with the drink. Advantageously, pod 300 maintain the freshness of coffee beans 303, but is mostly made of renewable materials and thus minimizes the environmental impact of pod 300.

FIG. 4 illustrates grind-and-brew beverage machine 400 that use pods 300 containing beverage-making ingredients according to an embodiment of the present disclosure. In the exemplary embodiment, grind-and-brew beverage machine 400 comprises water tank 405, water pump 410, heating element 415, control unit 435, user interface 440, milling apparatus 450, and pod holder 460. Water tank 405, water pump 410, heating element 415, control unit 435, and user interface 440 perform analogous functions to similar elements in FIG. 1 above and need not be discussed in additional detail. Pod holder 460 is a receptacle that holds pod 300 that contains, for example, whole or half coffee beans 303, before the grind-and-brew cycle. Those skilled in the art will understand that other beverage-making ingredients may be used instead of coffee beans 303. However, for purposes of simplicity and clarity, it shall be assumed that coffee beans 303 are being used unless otherwise indicated.

According to the principles of the present disclosure, pod 300 is used to hold both the whole or half coffee beans before grinding and to hold the fresh coffee grounds after the beans have been ground by milling apparatus 450. Milling apparatus 450 may grind or crush whole or half coffee beans into small coffee grounds. Milling apparatus 450 may include a grinder, or a blender, or a combination of grinding gears and blending blades, as well as a motor that drives the grinder (or blender), among other components.

Control unit 430 controls the various components of beverage machine 400 to complete the grind-and-brew cycle. Control unit 430 also communicates with user interface 440, which receives input commands from the user and displays digital readouts or signal lights to the user. Beverage machine 400 may comprise other components, as well. For example, an interrral water reservoir may be used to hold the hot water from heating element 415 before the water is injected into pod 300 in pod holder 460.

In one embodiment of the present disclosure, pod holder 460 is mechanically movable by, for example, an actuator motor or a manual lever. Beverage machine 400 moves pod holder 460 (and pod 300 inside) to different positions during a grind-and-brew cycle. Preferably, pod holder 460 is configured to move between at least two positions. The first position is a position where coffee beans 303 may be released into milling apparatus 450. The second position is a position where pod 300 may receive the coffee grounds from milling apparatus 450. There may be a third position in which the user is able to open pod holder 460, remove a used pod, and load a new pod into pod holder 460. In certain designs, this third position may be the same as either the first position or the second position.

As pod holder 460 moves to different positions, pod holder 460 may change its orientation. In one embodiment of the present disclosure, pod holder 460 may orient towards a first direction in a first position and orient towards a second direction in a second position. For example, pod holder 460 may be flipped upside down (or be oriented downwards) in the first position such that coffee beans 303 in pod 300 are able to drop into milling apparatus 450. Pod holder 460 may be held upright (or be oriented upwards) in the second position, such that pod 300 can receive the coffee grounds from milling apparatus 450.

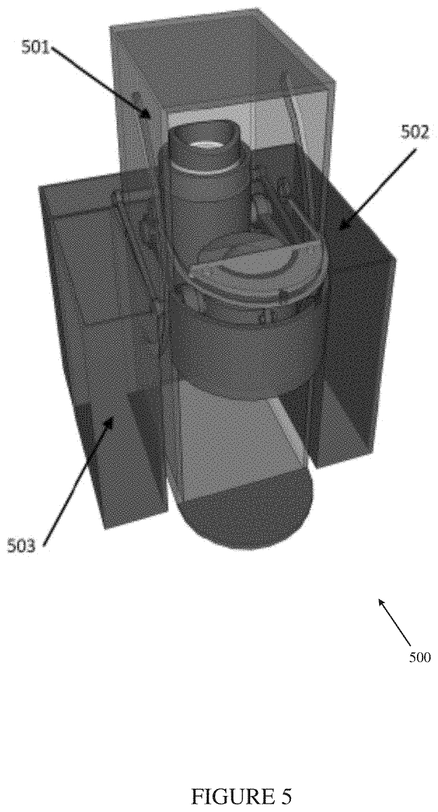

FIG. 5 illustrates grind-and-brew coffee machine 500 for pods 300 containing whole or halved coffee beans 303 according to an embodiment of the present disclosure. Coffee machine 500 comprises grind-and-brew module 501, main body module 502, and water tank 503. Similar to FIG. 4, grind-and-brew module 501 comprises a milling apparatus, an electric motor that drives the milling apparatus, a pod holder, and a mechanical arm that moves the pod holder to various positions in the grind-and-brew cycle. Water tank 503 holds water to be used for brewing coffee. Main body module 502 comprises other components of coffee machine 500, including a water pump, a water heater, a controller unit for coffee machine 500, and the like. In addition, coffee machine 500 may also include a user interface (not shown), such as buttons, knobs, levers, display panels, LEI) indicators, and the like.

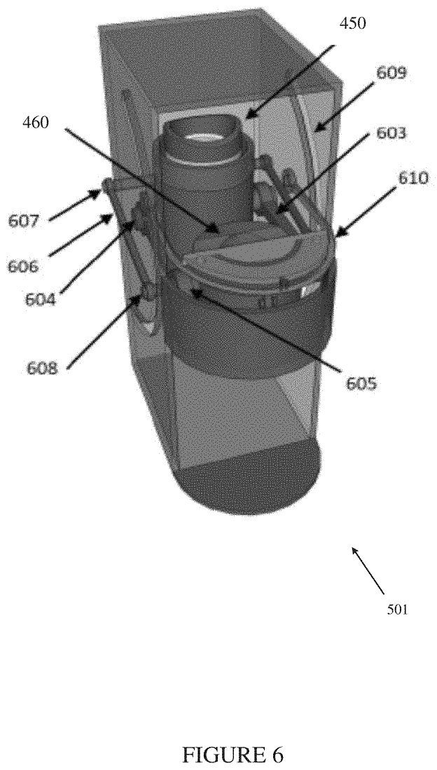

FIG. 6 illustrates grind-and-brew module 501 of grind-and-brew coffee machine 500 for pods 300 containing coffee beans 303 according to an embodiment of the present disclosure. Grind-and-brew module 501 comprises milling apparatus 450, pod holder 460, and first mechanical arm 603 that moves pod holder 460 into different positions during a grind-and-brew cycle. There can be many designs of the first mechanical arm to achieve the desired movements of the pod holder without departing from the scope of this disclosure.

For the purpose of illustration, it is assumed the first mechanical arm revolves around a first orbital axis 604 to move pod holder 460 to different positions. The first mechanical arm may be spring loaded. The first mechanical arm may also be bendable. In addition, pod holder 460 may rotate around rotational axis 605 to align the opening of pod holder 802 towards different angles in different states of the grind-and-brew cycle. To facilitate rotation of pod holder 460 around the rotational axis 605 as pod holder 460 moves to different positions, second mechanical arm 606 that revolves around second orbital axis 607 may be attached to pod holder 460 via off-rotational-axis bar 608. Second mechanical arm 606 may also be spring loaded and may also be bendable. Off-rotational-axis bar 608 is attached to pod holder 460 at a location away from rotational axis 605. Alternatively, guiding slot 609 for off-rotational-axis bar 608 may be used to facilitate rotation of pod holder 460 as pod holder 460 moves to different positions. Finally, coffee machine cover 610 may also be added to allow the user to open coffee machine 500 to access pod holder 460 (for loading and unloading pods), and to close coffee machine 500 during the grind-and-brew cycle.

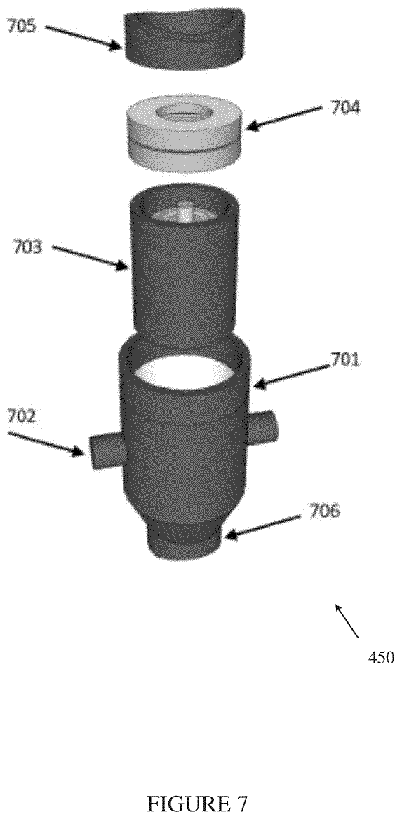

FIG. 7 is an exploded view that illustrates milling apparatus 450 of grind-and-brew coffee machine 500 for pods 300 containing coffee beans 303 according to an embodiment of the present disclosure. Milling apparatus 450 comprises enclosure 701, mount 702, motor 703, grinder 704, intake 705 for coffee beans 303 to enter grinder 704, and exit spout 706 for coffee grounds to exit milling apparatus 450. As the coffee beans 303 enter grinder 704 via intake 705, motor 703 drives grinder 704 to crush the coffee beans 303 into coffee grounds. The coffee grounds exit milling apparatus 450 via exit spout 706 due to gravity and the centrifugal force of grinder 704. In this example, the channel for the coffee grounds to pass from grinder 704 to exit spout 706 is the cylindrical ring formed between enclosure 701 and the outer shell of electric motor 703 when motor 703 is disposed inside of enclosure 701. Enclosure 701 is mounted onto the main body of coffee machine 500 via mount 702.

There are many other ways to design the channel without departing from the scope of this disclosure. For example, motor 703 may be mounted directly onto the main body of coffee machine 500, but enclosure 701 does not completely enclose motor 703. In such a case, the channel for the coffee grounds to pass from grinder 704 to exit spout 706 may be formed between enclosure 701 and grinder 704, and possibly part of the outer shell of motor 703.

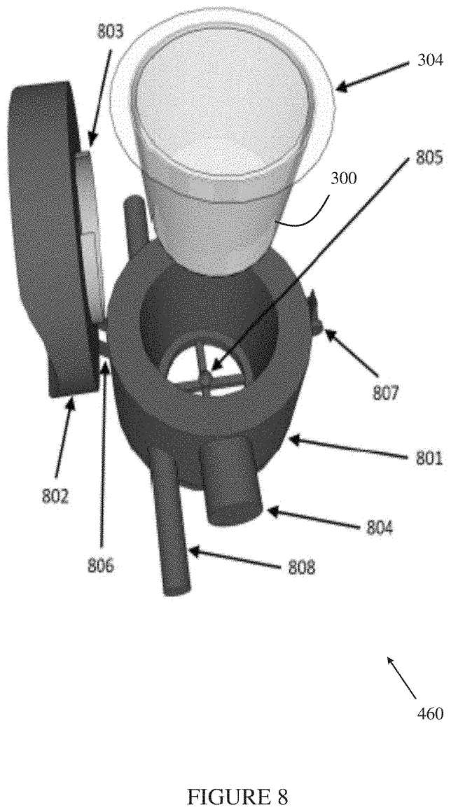

FIG. 8 illustrates pod holder 460 of grind-and-brew coffee machine 500 for pods 300 containing coffee beans 303 according to an embodiment of the present disclosure. Pod holder 460 comprises pod holder base 801, pod holder top 802, pod cover opener 803, rotational axis 804 that connects with the mechanical arm (not shown) for pod holder 460 to move into different positions in a grind-and-brew cycle, and off-rotational-axis bar 808 that facilitates the rotation of the pod holder as the pod holder moves to different positions. Pod cover opener 803 is attached to the pod holder top 802. In FIG. 8, pod 300 is positioned outside and above the opening of pod holder base 801.

In this example, pod cover opener 803 is an arc-shaped blade that cuts open pod cover 304 as pod holder top 802 closes towards pod holder base 801. Note that the arc-shaped blade does not cut a full circle in pod cover 304, so that pod cover 304 is still connected to pod 300 after pod cover 304 is cut open. Otherwise, the cutout may separate from pod cover 304 and fall into pod 300 or grinder 704. At the bottom of pod holder base 801, there is at least one needle 805 for puncturing the bottom of pod 300. Pod holder top 802 is attached to pod holder base 801 via hinge 806, which may be spring loaded. When pod 300 is being loaded into pod holder base 801, pod holder top 802 clamps down towards pod holder base 801. Due to this clamping motion, pod cover 304 is cut open by pod cover opener 803 and the bottom of pod 300 is punctured by needle 805. Once pod holder top 802 closes down, pod holder top 802 can be locked in position by a lock/release tab 807.

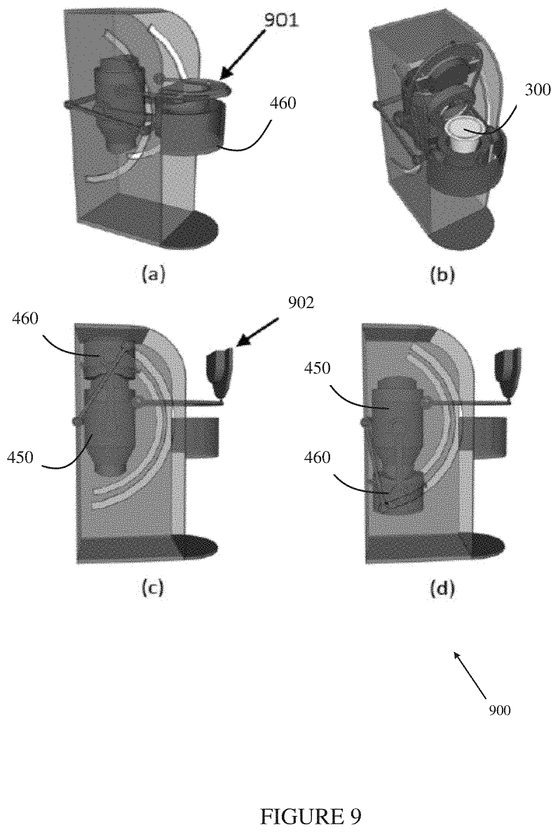

FIG. 9 is an illustration of the various states of coffee machine 500 in a grind-and-brew cycle according to an embodiment of the present disclosure. For the purpose of illustration, the outer wall of this exemplary coffee machine is shown as transparent and a portion of the outer wall is removed to reveal the inside of coffee machine 500.

FIG. 9(a) shows a first state of coffee machine 500. In this state, coffee machine cover 901 is closed and pod holder 460 is at a position above the space where a coffee mug or cup can be placed to receive the coffee drink. In this state, pod holder 460 may be empty, or contain a used pod, or a new pod.

FIG. 9(b) shows a second state of coffee machine 500. In this state, coffee machine cover 901 is open to reveal pod 300 in pod holder 460. The pod holder top can also be open to reveal the inside of pod holder 460. This is the state when the user opens the cover and the pod holder to load or unload pod 300.

FIG. 9(c) shows a third state of coffee machine 500. In this state, pod holder 460 is above milling apparatus 450. The opening of the pod holder is facing downward. This is the state when the coffee beans are transferred from pod 300 into milling apparatus 450 to make coffee grounds.

FIG. 9(d) shows a fourth state of coffee machine 500. In this state, pod holder 460 is below milling apparatus 450. The opening of the pod holder is facing upward. This is the state when the coffee grounds flow into pod 300 as milling apparatus 450 makes coffee grounds from coffee beans 303.

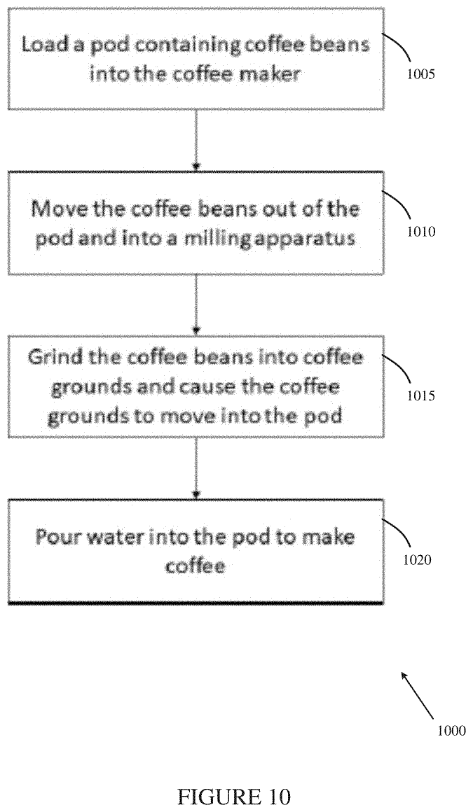

FIG. 10 is an exemplary flow diagram 1000 illustrating a method of making coffee drinks using grind-and-brew coffee machine 500 with pods 300 containing coffee beans 303 according to an embodiment of the present disclosure. In 1005, a user loads pod 300 containing coffee beans 303 into coffee machine 500. In 1010, coffee machine 500 moves coffee beans 303 from pod 300 into milling apparatus 450. In 1015, coffee machine 500 grinds coffee beans 303 into coffee grounds and moves the coffee grounds back into pod 300. Finally, in 1020, coffee machine 500 pours water into pod 300 to make coffee.

The actions in FIG. 10 may be directly caused by user actions such as pushing a button, pulling a lever, or turning a knob, or may be controlled by the control unit of coffee machine 500. The actions may be completed by different components of the coffee machine. For example, a user may need to open a coffee machine cover (e.g., by pulling the coffee machine cover to open, or by pushing a button, pulling a lever, or turning a knob). The user may need to manually put a pod into the coffee machine. The user may need to close the coffee machine cover (e.g., by pushing the coffee machine cover to close, or by pushing a button, pulling a lever, or turning a knob). In order for the coffee beans to be moved out of the pod and into the milling apparatus, the pod cover needs to be opened, and the coffee beans need to be transported into the milling apparatus.

There are many ways to achieve this transportation without departing from the scope of the present disclosure. For example, this transportation can be realized by moving the pod above the milling apparatus and dumping the coffee beans into the milling apparatus. The start and stop of the milling apparatus may be caused by user action or control signals from the control unit of the coffee machine. Note that if the pod has been moved to a position to dump the coffee beans into the milling apparatus, the pod may need to be moved to a different position to receive the coffee grounds. As the milling apparatus makes coffee grounds, the coffee grounds flow into the pod due to gravity, or centrifugal force, or other mechanisms. Water can be poured into the pod to make coffee. Note that it is not necessary to wait for the milling apparatus to stop before pouring water into the pod.

An exemplary grind-and-brew cycle is described in greater detail as follows.

Step 1—

Initially, the user opens the coffee machine cover and the pod holder top. Preferably, the user is only recommended or allowed to do so when the coffee machine is in the first state as shown in FIG. 9(a). There are many ways that the user can cause the coffee machine cover and the pod holder top to open without departing from the scope of the present disclosure. For example, the coffee machine cover and the pod holder top can be opened manually by user pulling a lever or turning a knob. Alternatively, the user can push a button to cause a motor to drive the coffee machine cover and the pod holder top to open. The user action may also cause the Lock/Release Tab 807 to release the pod holder top. With the spring loaded hinge 806, the pod holder top pops open to reveal the pod receptacle in the pod holder base 801.

Step 2—

The user puts a pod into the receptacle of the pod holder base, as shown in FIG. 9(b). If there is a used pod from previous cycle, the user removes the used pod first before putting in a new pod.

Step 3—

The user loads the pod into the coffee machine. In this step, the user causes the coffee machine cover 901 to close and the pod holder top 802 to close down towards the pod holder base 801. As the pod holder top 802 closes down, the pod cover opener 803 cuts into the cover of the pod. Upon completion of this step, the coffee machine will be back to the first state as shown in FIG. 9(a) with a new pod in the pod holder.

Step 4—

Coffee beans are dumped into the milling apparatus. Once the pod is loaded into the coffee machine, the user can cause the coffee machine to transition from the first state as shown in FIG. 9(a) to the third state as shown in FIG. 9(c). There are many ways that the user can cause this transition without departing from the scope of the present disclosure. For example, the user can push a button that causes a motor to drive the mechanical arm 603 to revolve around the orbital axis 604 and move the pod holder upward towards the upright position as shown in FIG. 9(c). Alternatively, since the user has already acted to cause the coffee machine to act in the previous step, the coffee machine (or the controller unit of the coffee machine) can also take the closing of the coffee machine cover (or the completion of the previous step) as a signal to start the transition without explicit action by the user.

Note that off-rotational-axis bar 608 (or 808) is attached to the second mechanical arm 606 that revolves around the second orbital axis 607. The movement of the bar can also be restricted by the guiding slot 609. As the pod holder moves up, the off-rotational-axis bar moves along the guiding slot 609. The end result is that the pod holder rotates around the rotational axis 605 as the pod holder moves up. Note the pod holder needs to pass through the coffee machine cover as it moves up. Once the pod holder is moved to the upright position as shown in FIG. 9(c), the pod holder opening should face downward so that the coffee beans can enter the milling apparatus through the coffee bean entrance 705. Because the cover of the pod is already cut open, the coffee beans fall into the milling apparatus via the entrance 705 due to gravity.

Step 5—

Grind the coffee beans and receive coffee grounds in the pod. Once the beans are in the milling apparatus, the coffee machine transitions to the fourth state as shown in FIG. 9(d). This movement can be effectuated by gravity and the pulling forces of springs attached to the first mechanical arm 603 or the second mechanical arm 606. Alternatively, this movement can be driven by a motor. Note the pod holder needs to pass through (or pass by) the coffee machine cover as it moves down.

Once the pod holder is moved to the downright position as shown in FIG. 9(d), the pod holder should stay in that position until it finishes receiving coffee grounds from the milling apparatus. As the coffee beans are turned into coffee grounds by the milling apparatus, the coffee grounds pass through exit spout 706 and enter into the pod. Around the same time, the water pump may pump water into the coffee machine and the water heater may heat up the water. If there is an internal water reservoir, it can hold the hot water until the time to release water into the pod (with coffee grounds inside).

Step 6—

Drip water through the coffee grounds in the pod to make coffee. Once the milling apparatus finishes grinding the coffee beans, the milling apparatus stops. This event can be triggered by a timer, or a sensor that can detect whether all (or most of) coffee beans have been ground, or a combination of both. This event may also cause the pod holder to be released from the downright position and move back to the position as shown in FIG. 9(a). This movement can be achieved by a spring loaded mechanical arm that pulls the pod holder towards the position as shown in FIG. 9(a), or being driven by a motor. Once the pod holder is in position, water starts to be pumped into the pod via a water nozzle (not shown). Preferably, the water nozzle should be placed to minimize the chance that water is poured onto the pod cover. The water passes through the coffee grounds, the filter within the pod, the hole at the bottom of the pod punctured by the needle 805, and a coffee spout and eventually drips into a coffee mug or cup.

Step 7—

Once a certain amount of water has been dispensed, the water heater and water pump shut off. This event can be triggered by a timer, or a flow meter that measures the amount of water that has been dispensed. The coffee machine may make certain indications to the user the coffee is ready. By this time, the grind-and-brew cycle completes and the coffee machine is ready for the next cycle.

As the user causes the coffee machine cover to open, the pod holder top may also open to reveal the inside of the pod holder. As the user causes the coffee machine cover to close, the pod holder top may close down onto the pod holder base. In these scenarios, the coffee machine cover and the pod holder need to be engaged or connected in certain fashion so that the opening/closing of the coffee machine cover and the pod holder can be coordinated. However, in some other scenarios, the pod holder and the coffee machine cover need to be disengaged or separated so that the pod holder can move to different positions during the grind-and-brew cycle. There are many ways to design the engaging/disengaging mechanism between the coffee machine cover and the pod holder without departing from the scope of the present disclosure.

In one embodiment of the present disclosure, a coffee machine with a movable coffee machine cover and a movable pod holder has at least two configurations. In at least a first configuration, the coffee machine cover and at least one part of the pod holder (e.g., the pod holder top) are mechanically coupled so that a user can act to cause both the coffee machine cover and the pod holder to open or close. In at least a second configuration, the coffee machine cover and the at least one part of the pod holder are mechanically separated so that the pod holder can move to different positions while the coffee machine cover stays at the same place. There are many ways to achieve the at least two configurations of the coffee machine.

In one embodiment of the present disclosure, a movable cover flap 902 may can be added on the coffee machine cover 901. In the first configuration, the flap is closed down and secured onto the coffee machine cover such that the coffee machine cover and the flap can push the pod holder top to close as the coffee machine cover closes down. In the second configuration, the flap is lifted up so that the pod holder can move from the position in the first state as shown in FIG. 9(a) to the other positions in the third state as shown in FIG. 9(c) and in the fourth state as shown in FIG. 9(d).

In another embodiment of the present disclosure, a motor is used to drive the movement of the coffee machine cover and the at least one part of the pod holder. In the at least first configuration, both the coffee machine cover and the at least one part of the pod holder (e.g., the pod holder top) can be mechanically coupled to the motor (e.g., via gears or axes) such at a user can cause the motor to drive both the coffee machine cover and the pod holder to open or close. In the at least second configuration, at least one of the two components—the coffee machine cover and the at least one part of the pod holder—is disengaged from the motor. Preferably, both the coffee machine cover and the at least one part of the pod holder are disengaged from the motor to allow the pod holder to move freely. Note in this case, the coffee machine cover is designed in such a way that it will not interfere with the movement of the pod holder when closed.

In another embodiment of the present disclosure, the milling apparatus grinds the coffee beans as the water heater heats up the water in the grind-and-brew cycle. This will shorten the total time for the coffee machine to make a cup of coffee. Depending on the design, there could be differences between the time when the milling apparatus starts, and the time when the water heater is turned on, and the time when the water pump is turned on without departing from the scope of the present disclosure. Nevertheless, it is beneficial to overlap the time it takes to grind the coffee beans and the time it takes to heat up water so that the overall time for the grind-and-brew cycle can be reduced.

In another embodiment of the present disclosure, the time instants when the plurality of electric components in the coffee machine are turned on are staggered to avoid large peaks of current. Multiple components that may consume significant amount of current will be turned on during the grind-and-brew cycle, including the electric motor that drives the grinder, the heating element that heats up the water, and the water pump that pumps the water from the water tank through the heating element into the pod, etc. Some of these components draw larger amount of current at start than the amount of current it needs to operate. It is therefore advantageous to avoid starting these components at the same time to reduce current spikes that may cause electric failure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A beverage brewing machine comprising:
a receptacle configured to receive a pod, the pod containing an ingredient to be brewed;
a grinding apparatus configured to grind large pieces of the ingredient into grounds suitable for brewing, the grinding apparatus having an intake and an exit;
a transfer mechanism configured to move the pod to a first position that allows the large pieces of the ingredient to be transferred from the pod to the grinding apparatus intake and further configured to move the pod to a second position that allows the grounds to be transferred from the grinding apparatus exit back to the pod; and
a water pump configured to inject water into the pod to thereby brew the grounds and produce a brewed beverage.

2. The beverage brewing machine as set forth in claim 1, wherein the transfer mechanism is manually operated by a user of the beverage brewing machine.

3. The beverage brewing machine as set forth in claim 1, wherein the transfer mechanism further comprises a motor configured to move the pod between the first position and the second position.

4. The beverage brewing machine as set forth in claim 1, wherein the receptacle comprises a blade configured to form an opening in a cover of the pod, wherein the opening in the cover enables the large pieces of the ingredient to be transferred from the pod to the grinding apparatus intake when the pod is in the first position.

5. The beverage brewing machine as set forth in claim 4, wherein the opening in the cover further enables the grounds to be transferred from the grinding apparatus exit to the pod when the pod is in the second position.

6. The beverage brewing machine as set forth in claim 5, wherein the opening in the cover enables the water to enter the pod.

7. The beverage brewing machine as set forth in claim 4, wherein the blade is associated with a lid of the receptacle and forms the opening in the cover of the pod when the lid is closed on the pod.

8. The beverage brewing machine as set forth in claim 1, wherein the receptacle comprises a sharpened point configured to puncture a hole in the pod, wherein the hole in the pod enables the brewed beverage to exit the pod.

9. The beverage brewing machine as set forth in claim 8, wherein the sharpened point is associated with a base of the receptacle and punctures the hole in the pod when the pod is inserted into the receptacle.

10. The beverage brewing machine as set forth in claim 1, further comprising a heating element configured to heat water from the pump, such that heated water is injected into the pod to thereby brew the grounds and produce a brewed beverage.

11. A method of brewing a beverage in a brewing machine comprising:
inserting into the brewing machine a pod containing large pieces of an ingredient to be brewed;
transferring the large pieces of the ingredient from the pod into a grinding apparatus;
grinding the large pieces of the ingredient into grounds suitable for brewing;
transferring the grounds from the grinding apparatus back into the pod; and
injecting water into the pod to thereby brew the grounds and produce a brewed beverage.

12. The method as set forth in claim 11, further comprising moving the pod to a first position to allow the large pieces of the ingredient to be transferred from the pod into the grinding apparatus.

13. The method as set forth in claim 12, further comprising moving the pod to a second position to allow the grounds to be transferred from the grinding apparatus back into the pod.

14. The method as set forth in claim 11, further comprising forming an opening in a cover of the pod to enable the large pieces of the ingredient to be transferred from the pod to the grinding apparatus.

15. The method as set forth in claim 14, wherein the opening in the cover further enables the grounds to be transferred from the grinding apparatus back into the pod.

16. The method as set forth in claim 15, wherein the opening in the cover further enables the water to enter the pod.

17. The method set forth in claim 14, wherein the opening in the cover is formed by a blade associated with a receptacle into which the pod is inserted in the brewing machine.

18. The method brewing machine as set forth in claim 11, further comprising heating the water before injecting the water into the pod.

19. A pod for brewing a beverage, the pod comprising:
an outer shell configured to form an enclosure;
a filter that lines the interior of the outer shell;
large pieces of ingredients within the enclosure, the large pieces of ingredients to be ground or blended before brewing; and
a pod cover that covers the enclosure.

20. The pod as set forth in claim 19, wherein the large pieces of ingredients are disposed within the filter inside the outer shell.

21. The pod as set forth in claim 19, wherein the filter, the outer shell, and the pod cover comprise a porous material.

22. The pod as set forth in claim 21, wherein the porous material is paper.

23. The pod as set forth in claim 21, wherein the outer shell and the pod cover are coated with food grade coating.

24. The pod as set forth in claim 19, wherein the filter comprises a porous material.

25. The pod as set forth in claim 24, wherein the porous material is paper.

26. The pod as set forth in claim 24, wherein the outer shell and the pod cover are coated with food grade coating.

27. The pod as set forth in claim 19, wherein the large pieces of ingredients include whole coffee beans.

28. The pod as set forth in claim 19, wherein the large pieces of ingredients include halved coffee beans.

29. A beverage brewing machine comprising:
a receptacle configured to receive a pod, the pod containing an ingredient to be brewed;
a grinding apparatus configured to grind large pieces of the ingredient into grounds suitable for brewing, the grinding apparatus having an intake and an exit;
a transfer mechanism configured to transfer the large pieces of the ingredient from the pod to the grinding apparatus intake and further configured to transfer the grounds from the grinding apparatus exit back to the pod; and
a water pump configured to inject water into the pod to thereby brew the grounds and produce a brewed beverage.

30. The beverage brewing machine as set forth in claim 29, wherein the transfer mechanism is manually operated by a user of the beverage brewing machine.

31. The beverage brewing machine as set forth in claim 29, wherein the transfer mechanism further comprises a motor configured to transfer the large pieces of the ingredient from the pod to the grinding apparatus intake and to transfer the grounds from the grinding apparatus exit back to the pod.

32. The beverage brewing machine as set forth in claim 29, wherein the receptacle comprises a blade configured to form an opening in a cover of the pod, wherein the opening in the cover enables the large pieces of the ingredient to be transferred from the pod to the grinding apparatus intake.

33. The beverage brewing machine as set forth in claim 32, wherein the opening in the cover further enables the grounds to be transferred from the grinding apparatus exit to the pod.

34. The beverage brewing machine as set forth in claim 33, wherein the opening in the cover enables the water to enter the pod.

35. The beverage brewing machine as set forth in claim 32, wherein the blade is associated with a lid of the receptacle and forms the opening in the cover of the pod when the lid is closed on the pod.

36. The beverage brewing machine as set forth in claim 29, wherein the receptacle comprises a sharpened point configured to puncture a hole in the pod, wherein the hole in the pod enables the brewed beverage to exit the pod.

37. The beverage brewing machine as set forth in claim 29, further comprising a heating element configured to heat water from the pump, such that heated water is injected into the pod to thereby brew the grounds and produce a brewed beverage.
